(19) United States
(12) Patent Application Publication
(10) Pub. No.: US 2026/0162225 A1
(43) Pub. Date: Jun. 11, 2026

(54) SYSTEM AND METHOD FOR FULL FRAME VIDEO STABILIZATION

(71) Applicant: Samsung Electronics Co., Ltd., Suwon-si (KR)

(72) Inventors: Pradeep Kumar SINDHAGATTA KRISHNAPPA, Bangalore (IN); Adithya Sudhir KAMATH, Bangalore (IN); Meghansh PUNJABI, Bangalore (IN); Mehul GOEL, Bangalore (IN); Prasanth KAMMAMPATI, Bangalore (IN); Kshitiz KUMAR, Bangalore (IN)

(21) Appl. No.: 19/428,892

(22) Filed: Dec. 22, 2025

Related U.S. Application Data
(63) Continuation of application No. PCT/IB2025/062579, filed on Dec. 9, 2025.

(30) Foreign Application Priority Data
Dec. 9, 2024 (IN) 202441097109

(51) Int. Cl. G06T 5/50; G06T 5/60; G06T 5/73; G06T 7/174; G06T 7/194; G06T 7/215; G06T 7/70; G06V 10/70; G06V 10/74; G06V 10/75; G06V 10/82

(52) U.S. Cl. CPC G06T 5/50; G06T 5/60; G06T 5/73; G06T 7/174; G06T 7/194; G06T 7/215; G06T 7/70; G06V 10/751; G06V 10/761; G06V 10/768; G06V 10/82; G06T 2207/10016; G06T 2207/20072; G06T 2207/20084; G06T 2207/20132; G06T 2207/20201; G06T 2207/20221

(57) ABSTRACT

A method for full frame video stabilization is provided. The method includes receiving a set of inputs including a plurality of first frames and a plurality of second frames from a first sensor and a second sensor respectively, of a video, determining an optimum crop margin for the video based on at least two frames among the plurality of first frames and the plurality of second frames, identifying one or more foreground objects within the optimum crop margin of each of the plurality of first frames, generating a plurality of background frames within the optimum crop margin for the corresponding plurality of first frames by removing the one or more foreground objects and corresponding shadows using segmentation, generating one or more flow field prompts corresponding to one or more foreground objects to be generated within the optimum crop margin of each of the plurality of first frames based on an object relationship context graph, generating, using a guided diffusion model, the one or more foreground objects for each of the plurality of background frames based on the one or more flow field prompts, and generating a cropped region within the optimum crop margin for each of the plurality of first frames based on the generated plurality of background frames and the generated one or more foreground objects.

### CROSS-REFERENCE TO RELATED APPLICATION(S)

This application is a continuation application, claiming priority under 35 U.S.C. § 365(c), of an International application No. PCT/IB2025/062579, filed on Dec. 9, 2025, which is based on and claims the benefit of an Indian patent application number 202441097109, filed on Dec. 9, 2024, in the Indian Intellectual Property Office, the disclosure of which is incorporated by reference herein in its entirety.

### TECHNICAL FIELD

The disclosure relates to image processing systems. More particularly, the disclosure relates to a system and method for full frame video stabilization.

### BACKGROUND ART

Electronic devices nowadays include a camera for recording video of a scene. When recording the scene, a user holding the mobile device might not be able to capture a stable scene due to shaking or wobbling motion of user's hand. Thus, causing the electronic device camera to capture each frame from a slightly different perspective, resulting in a shaky video.

In view of the above, video stabilization is a quintessential feature of video processing. In general, to perform video stabilization, the portion of a video frame is cropped to remove and/or reduce the shaking effect on the video frame. However, the cropping of the portion leads to loss of the field of view (FOV). Furthermore, key objects may get cropped out of the video frame leading to bad user experience.

FIG. 1 illustrates an example scenario 100 of video stabilization of a scene, according to the related art.

Referring to FIG. 1, a video corresponding to a scene is processed to perform video stabilization and a cropped image 102 is obtained. As evident, when the crop is applied to the scene, it leads to about 25% FOV loss 104.

Therefore, what the user sees and expects to be captured may not appear in the video due to stabilization cropping, making crop restoration a desirable feature. Further, the conventional technique to obtain maximum FOV video stabilization employ one of the following methods:—

Use a less crop margin—This method suffers from worse stabilization quality.

Use optimal crop margin and regenerate crop using interpolation—This method suffers from inaccuracy in regeneration and inability to accurately represent objects that have dynamic motion and go in-and-out of margin.

Further, the existing methods of inpainting or outpainting of scene tend to hallucinate details in the frames, leading to differences in the output and users' observation. While it is possible to guide the process using neighboring frames to obtain better output, it is not possible to accurately regenerate objects that get cropped across a large window of frames.

Therefore, in view of the above-mentioned problems, it is advantageous to provide an improved system and method that can overcome the above-mentioned problems and limitations associated with video stabilization feature of video recording.

The above information is presented as background information only to assist with an understanding of the disclosure. No determination has been made, and no assertion is made, as to whether any of the above might be applicable as prior art with regard to the disclosure.

### SUMMARY OF INVENTION

Aspects of the disclosure are to address at least the above-mentioned problems and/or disadvantages and to provide at least the advantages described below. Accordingly, an aspect of the disclosure is to provide a system and method for full frame video stabilization.

Additional aspects will be set forth in part in the description which follows and, in part, will be apparent from the description, or may be learned by practice of the presented embodiments.

In accordance with an aspect of the disclosure, a method for full frame video stabilization is provided. The method includes receiving a set of inputs including a plurality of first frames and a plurality of second frames from a first sensor and a second sensor respectively, of a video, determining an optimum crop margin for the video based on at least two frames among the plurality of first frames and the plurality of second frames, identifying one or more foreground objects within the optimum crop margin of each of the plurality of first frames, generating a plurality of background frames within the optimum crop margin for the corresponding plurality of first frames by removing the one or more foreground objects and corresponding shadows using segmentation, generating one or more flow field prompts corresponding to one or more foreground objects to be generated within the optimum crop margin of each of the plurality of first frame based on an object relationship context graph, generating, using a guided diffusion model, the one or more foreground objects for each of the plurality of background frames based on the one or more flow field prompts, and generating a cropped region within the optimum crop margin for each of the plurality of first frames based on the generated plurality of background frames and the generated one or more foreground objects.

In accordance with another aspect of the disclosure, a system for full frame video stabilization is provided. The system includes one or more processors and memory coupled with the one or more processors, including storage media storing instructions, wherein the instructions, when executed by the one or more processors individually or collectively, cause the system to receive a set of inputs including a plurality of first frames and a plurality of second frames from a first sensor and a second sensor respectively, of a video, determine an optimum crop margin for the video based on at least two frames among the plurality of first frames and the plurality of second frames, identify one or more foreground objects within the optimum crop margin of each of the plurality of first frames, generate a plurality of background frames within the optimum crop margin for the corresponding plurality of first frames by removing the one or more foreground objects and corresponding shadows using segmentation, generate one or more flow field prompts corresponding to one or more foreground objects to be generated within the optimum crop margin of each of the plurality of first frame based on an object relationship context graph, generate, using a guided diffusion model, the one or more foreground objects for each of the plurality of background frames based on the one or more flow field prompts, and generate a cropped region within the optimum crop margin for each of the plurality of first frames based on the generated plurality of background frames and the generated one or more foreground objects.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving a set of inputs comprising a plurality of first frames and a plurality of second frames from a first sensor and a second sensor respectively, of a video, determining an optimum crop margin for the video based on at least two frames among the plurality of first frames and the plurality of second frames, identifying one or more foreground objects within the optimum crop margin of each of the plurality of first frames, generating a plurality of background frames within the optimum crop margin for the corresponding plurality of first frames by removing the one or more foreground objects and corresponding shadows using segmentation, generating one or more flow field prompts corresponding to one or more foreground objects to be generated within the optimum crop margin of each of the plurality of first frames based on an object relationship context graph, generating, using a guided diffusion model, the one or more foreground objects for each of the plurality of background frames based on the one or more flow field prompts, and generating a cropped region within the optimum crop margin for each of the plurality of first frames based on the generated plurality of background frames and the generated one or more foreground objects.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a scenario of video stabilization of a scene, according to the related art;

FIG. 2 illustrates a pictorial diagram depicting an environment for full frame video stabilization, according to an embodiment of the disclosure;

FIG. 3 illustrates a block diagram of a system architecture for full frame video stabilization, according to an embodiment of the disclosure;

FIG. 4 illustrates a schematic block diagram of system modules and sub-modules associated with the system for generating full frame video stabilization, according to an embodiment of the disclosure;

FIG. 5 illustrates a sequence flow of operations performed by the system and/or the corresponding modules for generating full frame video stabilization, according to an embodiment of the disclosure;

FIG. 6 illustrates a schematic block diagram of a multi-sensor image alignment module, according to an embodiment of the disclosure;

FIG. 7A illustrates a schematic block diagram of an image registration module associated with the multi-sensor image alignment module, according to an embodiment of the disclosure;

FIG. 7B illustrates a scenario of an output generated by the image registration module, according to an embodiment of the disclosure;

FIG. 8 illustrates a scenario of an output of an Image Quality (IQ) matching module associated with the multi-sensor image alignment module, according to an embodiment of the disclosure;

FIG. 9A illustrates a schematic block diagram of a video stabilization module of the system for full frame video stabilization, according to an embodiment of the disclosure;

FIG. 9B illustrates a scenario of an output of the video stabilization module, according to an embodiment of the disclosure;

FIG. 9C illustrates a graphical representation of an optimal camera path for full frame video stabilization, according to an embodiment of the disclosure;

FIG. 10 illustrates a schematic block diagram of a crop restoration module of the system, according to an embodiment of the disclosure;

FIG. 11 illustrates a schematic block diagram of a gen-artificial intelligence (AI) module associated with the crop restoration module, according to an embodiment of the disclosure;

FIG. 12 illustrates a scenario for generating background and foreground portions by the gen-AI module, according to an embodiment of the disclosure;

FIG. 13A illustrates a scenario of frame regeneration when a crop regeneration region is within a higher FOV frame, according to an embodiment of the disclosure;

FIG. 13B illustrates a scenario of frame regeneration when the crop regeneration region is partially outside a higher FOV frame, according to an embodiment of the disclosure;

FIG. 14A illustrates a schematic block diagram of a FOV cognitive crop margin assessment module with the gen-AI module, according to an embodiment of the disclosure;

FIG. 14B illustrates a crop margin scale, according to an embodiment of the disclosure;

FIG. 15A illustrates a schematic block diagram of a frame blending module of the system, according to an embodiment of the disclosure;

FIG. 15B illustrates a scenario of a crop regenerated frame by the frame blending module, according to an embodiment of the disclosure;

FIG. 16A illustrates a schematic block diagram of a segmented context extraction module of the system, according to an embodiment of the disclosure;

FIGS. 16B, 16C, and 16D illustrate methods for segmentation by the segmented context extraction module, according various embodiments of the disclosure;

FIG. 17A illustrates a schematic block diagram of a context based prompt generation module of the system, according to an embodiment of the disclosure;

FIG. 17B illustrates a scenario for generating one or more flow field prompts for a target object by the context based prompt generation module, according to an embodiment of the disclosure;

FIG. 18A illustrates a schematic block diagram of an object and shadow removal module of the system, according to an embodiment of the disclosure;

FIG. 18B illustrates a scenario for generating video frames with objects and shadows removed by the object and shadow removal module, according to an embodiment of the disclosure;

FIG. 19A illustrates a schematic block diagram of a block-wise neighboring frame-based generation module, according to an embodiment of the disclosure;

FIG. 19B illustrates a scenario for generating frames with regenerated backgrounds by the block-wise neighboring frame based generation module, according to an embodiment of the disclosure;

FIG. 20A illustrates a schematic block diagram of a guided diffusion model of the system, according to an embodiment of the disclosure;

FIG. 20B illustrates a scenario for generating crop regenerated video frames by the guided diffusion model, according to an embodiment of the disclosure;

FIG. 21A illustrates a schematic block diagram of a frame validation module, according to an embodiment of the disclosure;

FIG. 21B illustrates a scenario for frame validation by the frame validation module of the system, according to an embodiment of the disclosure; and

FIG. 22 illustrates a flow chart showing a method for full frame video stabilization, according to an embodiment of the disclosure.

Throughout the drawings, it should be noted that like reference numbers are used to depict the same or similar elements, features, and structures.

### DESCRIPTION OF EMBODIMENTS

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Hereinafter, it is understood that terms including “unit” or “module” at the end may refer to the unit for processing at least one function or operation and may be implemented in hardware, software, or a combination of hardware and software.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

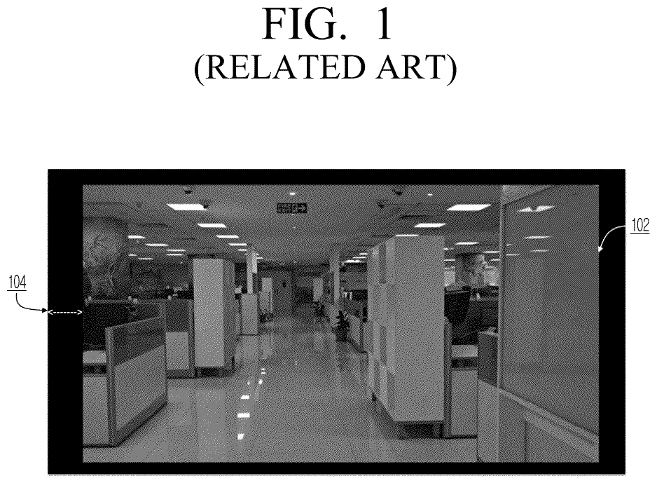

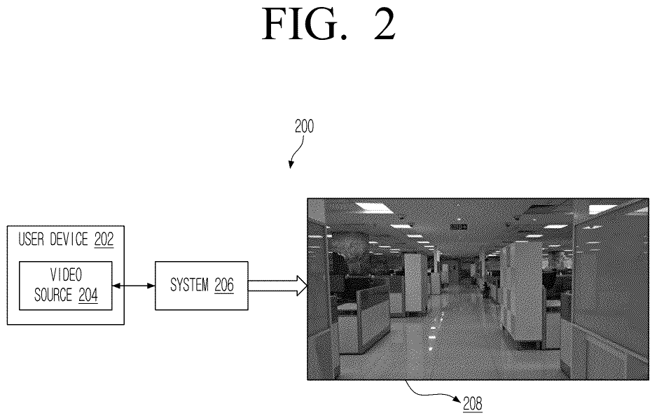

For the sake of clarity, the first digit of a reference numeral of each component of the disclosure is indicative of the FIG. number, in which the corresponding component is shown. For example, reference numerals starting with digit “1” are shown at least in FIG. 1. Similarly, reference numerals starting with digit “2” are shown at least in FIG. 2.

An object of the disclosure is to provide an improved technique to overcome the above-described limitations associated with existing video stabilization methods and enable usage of high crop margin to boost the quality of video stabilization.

Another object of the disclosure is accurately regenerating the cropped regions through a context-based guiding mechanism thereby generating objects with high degrees of accuracy.

Further object of the disclosure is crop restoration of stabilized video using multi-sensor data, which allows for intelligent margin calculation and more precise regeneration, and using object context based prompts to accurately regenerate out-of-bounds regions.

Embodiments of the disclosure will be described below in detail with reference to the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

FIG. 2 illustrates a pictorial diagram depicting an environment 200 for full frame video stabilization, according to an embodiment of the disclosure.

Referring to FIG. 2, an electronic device 202 provides a video source 204 as an input to a system 206 for full frame video stabilization. The input video source 204 is sent via a network interface to the system 206. The system 206 generates the full frame video stabilization as output 208, based on the video source 204 received from the electronic device 202.

The system 206 may include software, hardware, a combination of software or hardware, an in-built application on the electronic device 202 or an application to be installed and operated on the electronic device 202 in communication with a network interface. The system 206 may also be available via cloud-based server and available remotely from the electronic device.

The network interface may be configured to provide network connectivity and enable communication with paired devices such as the system 206. The network connectivity may be provided via a wireless connection or a wired connection. For example, the network connectivity may be provided via cellular technology, such as 3rd Generation (3G), 4^{th} Generation (4G), 5^{th} Generation (5G), pre-5G, 6^{th} Generation (6G), or any other wireless communication technology such as Bluetooth.

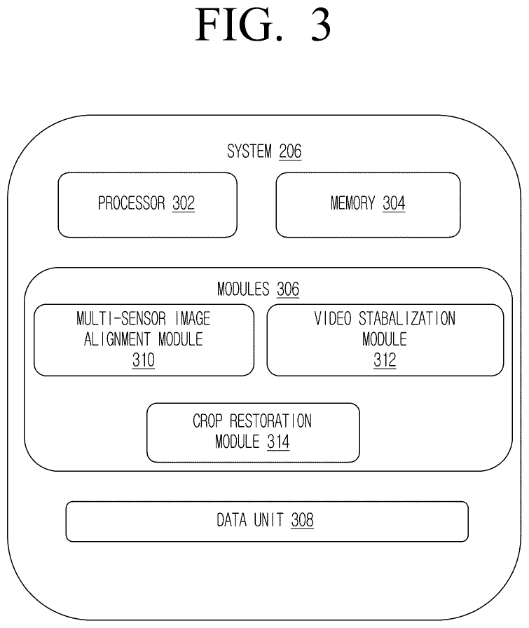

FIG. 3 illustrates a block diagram of an architecture of a system for full frame video stabilization, according to an embodiment of the disclosure.

Referring to FIG. 3, the system 206 generates full frame video stabilization based on the video source 204 received from the electronic device 202.

The system 206 may include one or more processors 302 (hereinafter referred to as the processor 302) which is communicatively coupled to memory 304, one or more modules 306, and a data unit 308.

The processor 302 may be implemented as one or more microprocessors, microcomputers, microcontrollers, digital signal processors, central processing units, state machines, logic circuitries, and/or any devices that manipulate signals based on operational instructions. Among other capabilities, the processor 302 may be configured to fetch and execute computer-readable instructions and data stored in the memory 304. The processor 302 may be a general-purpose processor, such as a central processing unit (CPU), an application processor (AP), or the like, and an AI-dedicated processor such as a neural processing unit (NPU). The processor 302 may control the processing of input data in accordance with a predefined operating rule or artificial intelligence (AI) model stored in the non-volatile memory and the volatile memory (i.e., the memory 304). The predefined operating rule or artificial intelligence model is provided through training or learning. Further, the processor 302 may be operatively coupled to each of the memory, the input/output (I/O) Interface. The processor 302 may be configured to process, execute, or perform a plurality of operations described herein.

The memory 304 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 304 is communicatively coupled with the processor 302 to store processing instructions for completing the process. Further, the memory 304 may include an operating system for performing one or more tasks of the system, as performed by a generic operating system in a computing domain. The memory 304 is operable to store instructions executable by the processor 302.

The one or more modules 306 may include a set of instructions that can be executed to cause the system 206 to perform any one or more of the methods disclosed. The system 206 may operate as a standalone device or may be connected, e.g., using a network, to other computer systems or peripheral devices. Further, while a single system 206 is illustrated, the term “system” shall also be taken to include any collection of systems or sub-systems that individually or jointly execute a set, or multiple sets, of instructions to perform one or more computer functions.

The module(s) 306 may be implemented using one or more artificial intelligence (AI) modules that may include a plurality of neural network layers. Examples of neural networks include but are not limited to, Convolutional Neural Network (CNN), Deep Neural Network (DNN), Recurrent Neural Network (RNN), and Restricted Boltzmann Machine (RBM). Further, ‘learning’ may be referred to in the disclosure as a method for training a predetermined target device (for example, a robot) using a plurality of learning data to cause, allow, or control the target device to make a determination or prediction. Examples of learning techniques include, but are not limited to supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with an AI module may be performed through the non-volatile memory, the volatile memory, and the processor. The processor may include one or a plurality of processors. One or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor, such as a neural processing unit (NPU). One or a plurality of processors control the processing of the input data in accordance with a predefined operating rule or artificial intelligence (At) model stored in the non-volatile memory and the volatile memory. The predefined operating rule or artificial intelligence model is provided through training or learning.

The processor may include one or a plurality of processors. The processors may include a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or more processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning technique to a plurality of learning data, a predefined operating rule or AI model of a desired characteristic is made. The learning may be performed in a device itself in which AI according to an embodiment is performed, and/or may be implemented through a separate server/system.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

The data unit 308 may server, among other things, as a repository for storing data processed, received, and generated by one or more of the modules 306.

The system 206 may include one or more modules 306, such as a multi-sensor image alignment module 310, a video stabilization module 312 and a crop restoration module 314. The multi-sensor image alignment module 310, the video stabilization module 312 and the crop restoration module 314 are communicably coupled with each other.

The multi-sensor image alignment module 310 may be configured to receive a set of inputs comprising a plurality of first frames and a plurality of second frames from a first sensor and a second sensor respectively, of a video. The multi-sensor image alignment module 310 may be configured to receive video frames having different Field of Views (FOVs) from the first sensor and the second sensor. The first and second sensor may correspond to the video source 204. Further, there may be multiple such sensors having different field of views. The multi-sensor image alignment module 310 may be configured to align the frames obtained from the first sensor and the second sensor (having different FOVs) and match the image quality (IQ) of the frames so that they are used interchangeably in other modules, reference being the lower FOV frame.

The video stabilization module 312 may be configured to receive the video frames having a lower FOV as an input to shift and crop the lower FOV image from frame to frame, to counteract a motion. Thus, the video stabilization module 312 may be configured to obtain an optimal camera path for the lower FOV Video.

The crop restoration module 314 may be configured to receive aligned video frames from the multi-sensor image alignment module 310 and the optimal camera path from the video stabilization module 312 as an input to regenerate a crop region in the frame determined by the optimal camera path using object relation tracking and context-based prompt generation. The crop regenerated frame is then validated.

The crop restoration module 314 may be configured to determine an optimum crop margin for the video based on at least two frames among the plurality of first frames and the plurality of second frames. The crop restoration module 314 may be configured to identify one or more foreground objects within the optimum crop margin of each of the plurality of first frames. the crop restoration module 314 may be configured to generate a plurality of background frames within the optimum crop margin for the corresponding plurality of first frames by removing the one or more foreground objects and corresponding shadows using the segmentation. The crop restoration module 314 may be configured to generate one or more flow field prompts corresponding to one or more foreground objects to be generated within the optimum crop margin of each of the plurality of first frame based on an object relationship context graph. The crop restoration module 314 may be configured to generate, using a guided diffusion model, the one or more foreground objects for each of a plurality of background frames based on the one or more flow field prompts. The crop restoration module 314 may be configured to generate a cropped region within the optimum crop margin for each of the plurality of first frames based on the generated plurality of background frames and the generated one or more foreground objects.

The crop restoration module 314 may be configured to determine one or more characteristics corresponding to the one or more foreground objects. The one or more characteristics comprises one or more of a motion, a position, and a size of the one or more foreground objects. The crop restoration module 314 may be configured to obtain the relationship context graph based on the determined one or more characteristics of each of the foreground objects with respect to each other.

The crop restoration module 314 may be configured to split the plurality of first frames and the plurality of second frames into a plurality of foreground frames and a plurality of background frames. In the plurality of background frames, one or more portions are stationary relative to the background and in the plurality of foreground frames one or more portions of the plurality of first frames and the plurality of second frames which is in motion relative to the background.

The crop restoration module 314 may be configured to obtain a bounding box corresponding to each of the one or more foreground objects. The crop restoration module 314 may be configured to determine a motion vector of to the each of one or more foreground objects within the corresponding bounding box. The crop restoration module 314 may be configured to determine a feature vector of the segmented one or more foreground objects within the bounding box. Further, the crop restoration module 314 may be configured to obtain the object relationship context graph based on the determined motion vector and the determined feature vector corresponding to each of the one or more foreground objects.

The crop restoration module 314 may be configured to obtain an initial crop margin value and an ideal crop margin value for each of the plurality of first frames. The crop restoration module 314 may be configured to determine a tradeoff between the initial crop margin value and the ideal crop margin value to re-estimate the optimum crop margin for each of the plurality of first frames to generate a valid plurality of foreground frames. The crop restoration module 314 may be configured to extrapolate the optimum cropped margin from the plurality of background frames if the candidate frames are not identified.

The crop restoration module 314 may be configured to extract one or more features from the optimum cropped margin using at least one of one or more predetermined image processing techniques and one or more pre trained Convolution Neural Networks (CNNs), wherein the one or more features comprises one or more of color histogram, edge detection, texture pattern. The crop restoration module 314 may be configured to search for the extracted one or more features in neighboring frames through a frame-by-frame comparison. The crop restoration module 314 may be configured to combine one or more factors such as blur, sharpness and Image Quality (IQ) similarity with interpolation technique to identify candidate frames for blending the plurality of background frames in the optimum cropped margin.

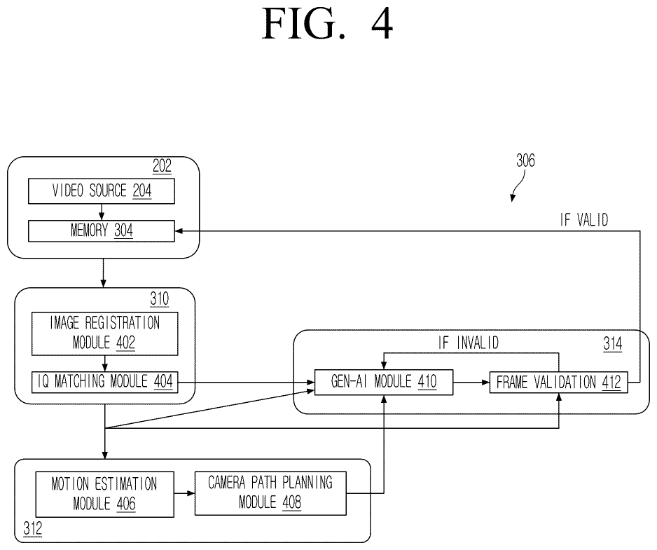

FIG. 4 illustrates a schematic block diagram of system modules and sub-modules associated with the system for generating full frame video stabilization, according to an embodiment of the disclosure.

Referring to FIG. 4, the system 206 may include one or more modules 306, such as a multi-sensor image alignment module 310, a video stabilization module 312 and a crop restoration module 314. The multi-sensor image alignment module 310, the video stabilization module 312 and the crop restoration module 314 are communicably coupled with each other.

Referring to FIG. 4, the multi-sensor image alignment module 310 includes sub-modules such as an image registration module 402 and an IQ matching module 404. The image registration module 402 and the IQ matching module 404 are communicably coupled with each other. The video stabilization module 312 includes sub-modules such as a motion estimation module 406 and a camera path planning module 408. The motion estimation module 406 and the camera path planning module 408 are communicably coupled with each other. Further, the camera path planning module 408 includes sub-modules such as a gen-AI module 410 and frame validation 412. The gen-AI module 410 and the frame validation 412 are communicably coupled with each other.

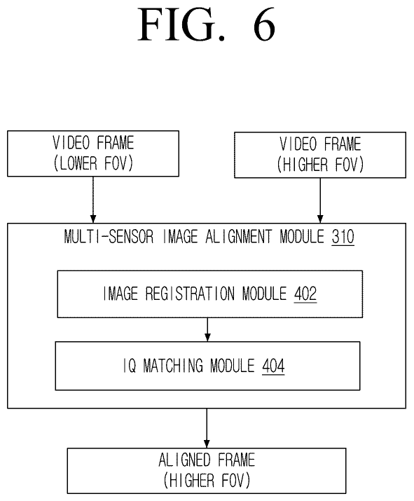

The detailed explanation of the working on each of the sub-modules is described below in detail in conjunction with FIGS. 6, 7A, 7B, 8, 9A, 9B, 10 to 12, 13A, 13B, 14A, 14B, 15A, 15B, 16A to 16D, 17A, 17B, 18A, 18B, 19A, 19B, 20A, 20B, 21A, and 21B.

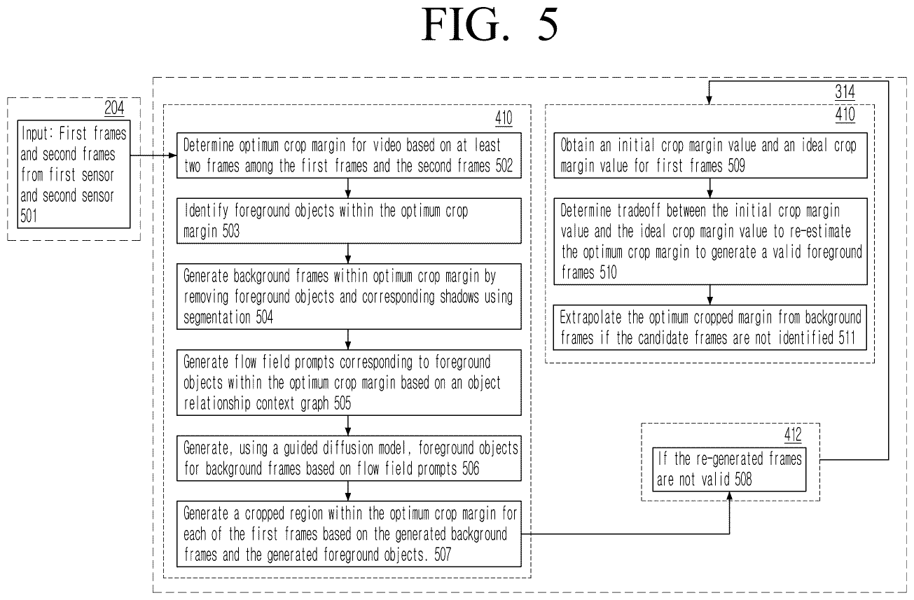

FIG. 5 illustrates a sequence flow of operations performed by a system and/or corresponding modules for generating full frame video stabilization, according to an embodiment of the disclosure.

Referring to FIG. 5, initially, at operation 501, the video source 204 is configured to provide a set of an input comprising a plurality of first frames and a plurality of second frames from a first sensor and a second sensor respectively, of a video, to the gen-AI module 410.

At operation 502, the gen-AI module 410 is configured to determine an optimum crop margin for the video based on at least two frames among the plurality of first frames and the plurality of second frames.

At operation 503, the gen-AI module 410 is configured to identify one or more foreground objects within the optimum crop margin of each of the plurality of first frames.

At operation 504, the gen-AI module 410 is configured to generate a plurality of background frames within the optimum crop margin for the corresponding plurality of first frames by removing the one or more foreground objects and corresponding shadows using the segmentation.

At operation 505, the gen-AI module 410 is configured to generate one or more flow field prompts corresponding to one or more foreground objects to be generated within the optimum crop margin of each of the plurality of first frame based on an object relationship context graph.

At operation 506, the gen-AI module 410 is configured to generate, using a guided diffusion model, the one or more foreground objects for each of a plurality of background frames based on the one or more flow field prompts.

At operation 507, the gen-AI module 410 is configured to generate a cropped region within the optimum crop margin for each of the plurality of first frames based on the generated plurality of background frames and the generated one or more foreground objects.

At operation 508, the frame validation module 412 is configured to check if the generated cropped region is valid or not. In case, the generated crop region is invalid, then the gen-AI module 410 is configured to process operations 509 onwards.

At operation 509, the gen-AI module 410 is configured to obtain an initial crop margin value and an ideal crop margin value for each of the plurality of first frames.

At operation 510, the gen-AI module 410 is configured to determine a tradeoff between the initial crop margin value and the ideal crop margin value to re-estimate the optimum crop margin for each of the plurality of first frame to generate a valid plurality of foreground frames.

At operation 511, the gen-AI module 410 is configured to extrapolate the optimum cropped margin from the plurality of background frames if the candidate frames are not identified.

FIG. 6 illustrates a schematic block diagram of a multi-sensor image alignment module 310, according to an embodiment of the disclosure.

Referring to FIG. 6, the multi-sensor image alignment module 310 comprises submodules including the image registration module 402 and the IQ matching module 404.

The multi-sensor image alignment module 310 receives video frames having different Field of Views (FOVs) from the first sensor and the second sensor. The multi-sensor image alignment module 310 then aligns the frames obtained from the first sensor and the second sensor (having different FOVs) and matches the image quality (IQ) of the frames to generate aligned frames of higher FOV. In other words, the higher FOV frames are aligned to the reference (lower FOV) frame.

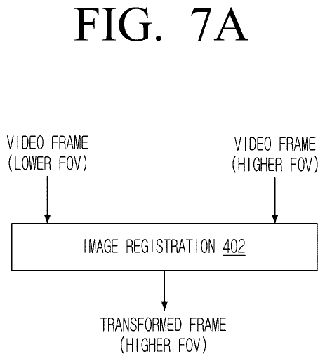

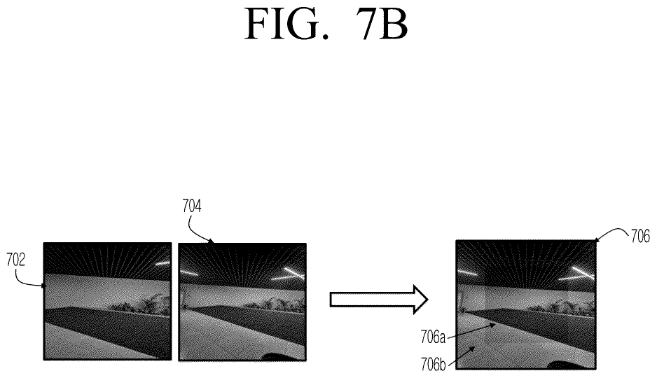

FIG. 7A illustrates a schematic block diagram of an image registration module 402 associated with a multi-sensor image alignment module, according to an embodiment of the disclosure.

Referring to FIG. 7A, the image registration module 402 receives video frames having different Field of Views (FOVs) from the first sensor and the second sensor. The image registration module 402 finds matching features in the frames and applies transform on higher FOV frames to match the corresponding locations of features with that of reference (lower FOV) frame.

The image registration module 402 performs the following operations:

Feature detection—In this operation, the image registration module 402 uses fast key-point detectors like Oriented FAST and Rotated BRIEF (ORB) on the frames.

Feature matching—In this operation, the image registration module 402 performs feature matching methods like nearest neighbors to know the corresponding locations of features in the frames.

Transformation estimation—In this operation, the image registration module 402 estimates transform to be applied on higher FOV frames using affine transform estimators.

Transformation application—In this operation, the image registration module 402 wraps the frames using affine transform according to the estimated parameters.

FIG. 7B illustrates a scenario of an output generated by the image registration module 402, according to an embodiment of the disclosure.

Referring to FIG. 7B, an image 702 is a video frame of low FOV and an image 704 is a video frame of higher FOV. The image registration module 402 transforms the high FOV frame 704 and superimposes the lower FOV 702 frame on the higher FOV frame 704 for checking accuracy of image registration and generates an output image 706. As shown, image quality is different between the lower FOV frame 706a and higher FOV frame 706b. This difference in the image quality of the lower FOV frame 706a and higher FOV frame 706b is fixed in next submodule: the IQ matching module 404.

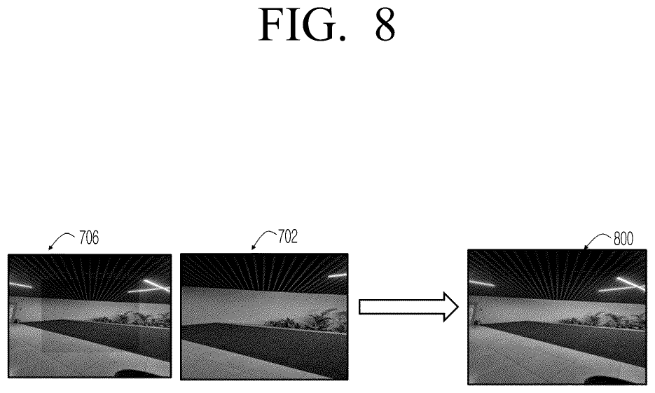

FIG. 8 illustrates a scenario of an output of an IQ matching module associated with a multi-sensor image alignment module, according to an embodiment of the disclosure.

Referring to FIG. 8, the IQ matching module 404 receives the transformed frame with higher FoV 706 and the lower FoV video frame 702. The IQ matching module 404 matches the quality of the transformed video frames 706 with the lower FoV video frames 702 as reference and ensures that the video frames 800 within a sequence have consistent video quality. Thus, the output of the IQ matching module 404 is aligned with the transformed video frame 800 with same quality matched with lower FOV frame 702.

The IQ matching module 404 may perform the following operations:

Adjusting Brightness and Contrast—In this operation, the IQ matching module 404 uses White Black (WB) Balance Gain and Color Correction Matching (CCM) matrix to adjust the color brightness and contrast of the transformed frame. The IQ matching module 404 then uses histogram matching to obtain the intensity distribution of image channels and match the histogram of the transformed frame.

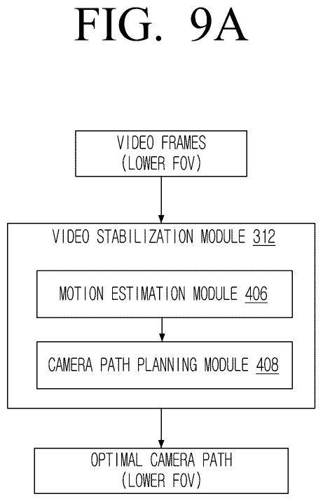

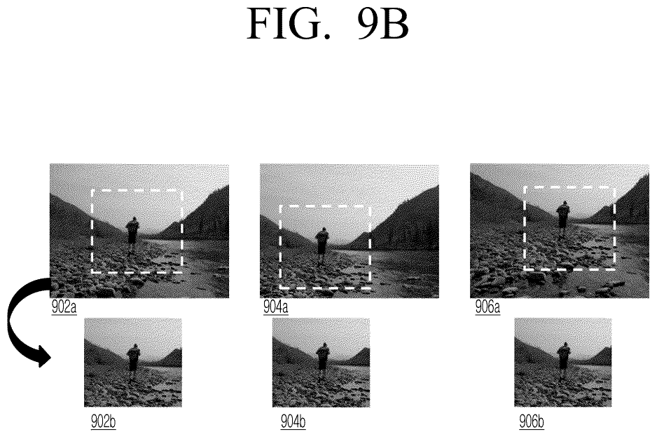

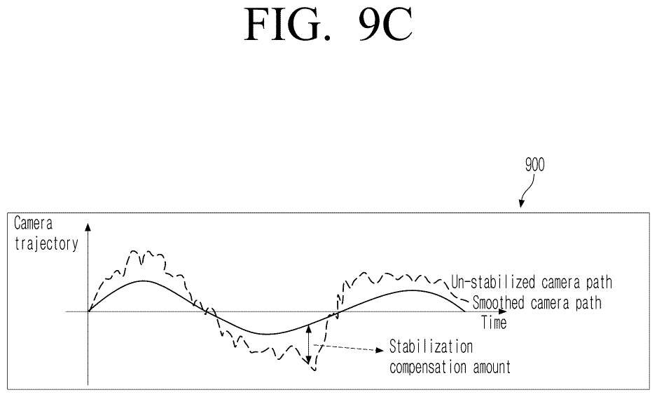

FIG. 9A illustrates a schematic block diagram of a video stabilization module of the system for full frame video stabilization according to an embodiment of the disclosure.

Referring to FIG. 9A, the video stabilization module 312 comprises submodules including the motion estimation module 406 and the camera path planning module 408.

The video stabilization module 312 may be configured to receive the video frames having lower FOV as an input to shift and crop the lower FOV image from frame to frame, enough to counteract the motion. Thus, the video stabilization module 312 may be configured to obtain Optimal Camera Path for the lower FOV Video.

FIG. 9B illustrates a scenario of an output of a video stabilization module, according to an embodiment of the disclosure.

Referring to FIG. 9B, images 902a, 904a and 906a depict a crop window in white dotted lines which indicates moving the crop window against the direction of camera motion to compensate shake. Thus, the final output is cropped as shown in images 902b, 904b and 906b.

The motion estimation module 406 may receive video frames having lower FOV. The motion estimation module 406 calculates the camera movement parameters for the current lower FOV frame obtained from the multi-sensor image alignment module 310 with respect to its previous frame. Thus, the output from the motion estimation module 406 is motion parameters for the current lower FOV frames.

The motion estimation module 404 may perform the following steps:

Estimate Global Motion Vector: In this operations, the motion estimation module 404 uses an Integral Projection method based on the principle of Sum over Absolute Differences (SAD) to estimate global motion vectors. Then, the motion estimation module 404 calculates motion vectors using SIFT point feature detection and optical flow to calculate global motion for each lines along X, Y and Z axes.

FIG. 9C illustrates a graphical representation 900 of optimal camera path for full frame video stabilization, according to an embodiment of the disclosure.

Referring to FIG. 9C, the camera path planning module 408 receives motion parameters for the current lower FOV frames. The camera path planning module 408 estimates a newly stabilized path of camera and calculates the relative angle difference between the original and new camera path along the X, Y and Z axes for the lower FOV video. Thus, the camera path planning module 408 generates an optimal camera path and its corresponding optimal margin for the lower FOV Video.

The camera path planning module 408 may use a low-pass filter or Gaussian filter to suppress high frequency jitter in the original camera path and estimate a stabilized camera path.

FIG. 9C shows camera trajectory over time to obtain un-stabilized camera path, smooth camera path, stabilized compensation amount.

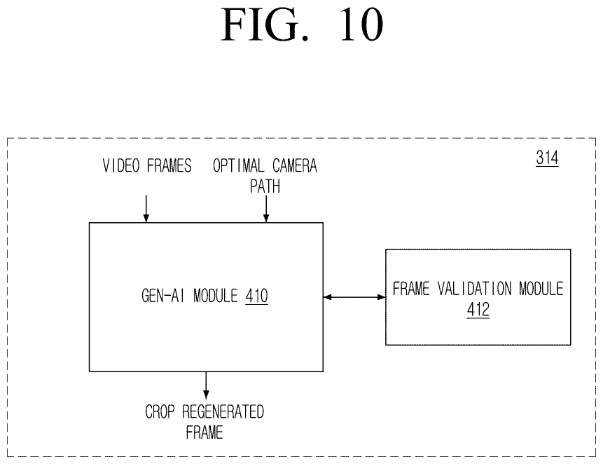

FIG. 10 illustrates a schematic block diagram of a crop restoration module of the system, according to an embodiment of the disclosure.

Referring to FIG. 10, the crop restoration module 314 comprises submodules including the gen-AI module 410 and the frame validation 412.

The crop restoration module 314 may be configured to receive aligned video frames from the multi-sensor image alignment module 310 and the optimal camera path from the video stabilization module 312 as an input to regenerate a crop region in the frame determined by the optimal camera path using object relation tracking and context-based prompt generation. The crop regenerated frame is then validated.

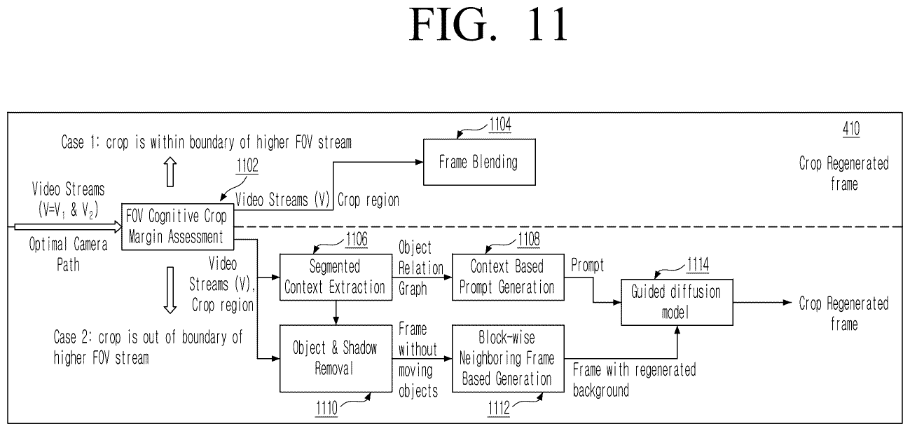

FIG. 11 illustrates a schematic block diagram of a gen-AI module 410 within a crop restoration module, according to an embodiment of the disclosure.

Referring to FIG. 11, the gen-AI module 410 comprises submodules including a FOV cognitive crop margin assessment module 1102, a frame blending module 1104, a segmented context extraction module 1106, a context based prompt generation module 1108, an object and shadow removal module 1110, a block-wise neighboring frame based generation module 1112, and a diffusion module.

The FOV cognitive crop margin assessment module 1102, the frame blending module 1104, the segmented context extraction module 1106, the context based prompt generation module 1108, the object and shadow removal module 1110, the block-wise neighboring frame based generation module 1112 and the diffusion module are communicably coupled with each other.

The gen-AI module 410 receives aligned video frames from the multi-sensor image alignment module 310 and the optimal camera path from the video stabilization module 312 as an input to generate a crop regenerated frame.

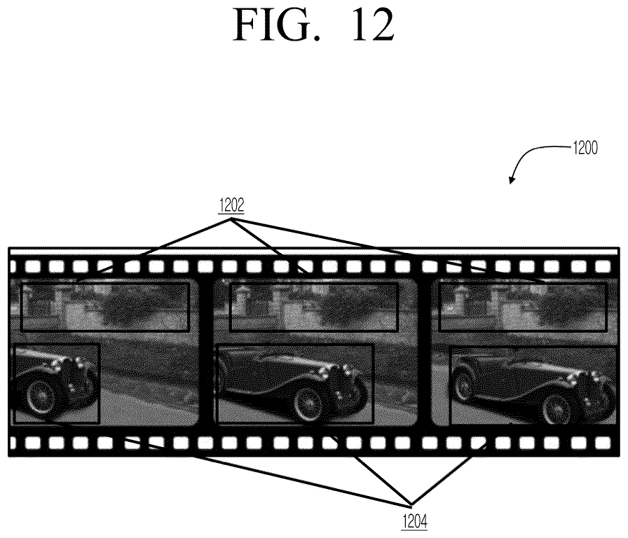

FIG. 12 illustrates a scenario 1200 for generating a background and a foreground by a gen-AI module, according to an embodiment of the disclosure.

Referring to FIG. 12, the gen-AI module 410 splits the frames into two parts based on segmentation: a) Background portions 1202 and b) Foreground portions 1204.

In an embodiment shown in FIG. 12, the background portions 1202 of the frame are stationary relative to camera motion and the foreground portions 1204 of the frame are moving relative to camera motion.

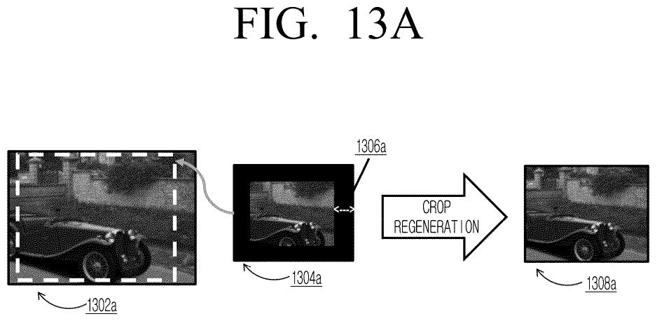

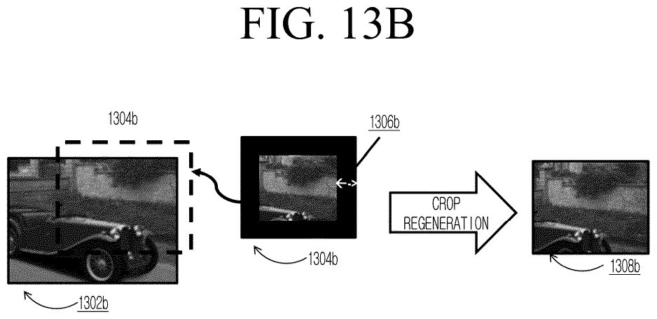

After stabilization, part of the frame gets cropped, and the two cases arise after cropping: when crop regeneration region is WITHIN higher FOV frame and when crop regeneration region is partially OUTSIDE higher FOV frame. An explanation of the two cases is described below with reference to FIGS. 13A and 13B.

FIG. 13A illustrates a scenario of frame regeneration when crop regeneration region is within higher FOV frame, according to an embodiment of the disclosure.

Referring to FIG. 13, In case 1, when crop regeneration region is WITHIN higher FOV frame, then direct frame blending is applied with higher FOV frame using the modules the FOV cognitive crop margin assessment module 1102 and the frame blending module 1104 to obtain crop regenerated frame.

Referring to FIG. 13A, a crop regeneration region 1304a is shown in an image with higher FOV frame 1302a. Image 1304a represents a cropped low FOV frame with cropped margin 1306a, thus generating a crop regeneration image 1308a.

FIG. 13B illustrates a scenario of frame regeneration when crop regeneration region is partially outside higher FOV frame, according to an embodiment of the disclosure.

Referring to FIG. 13, in case 2, when the crop regeneration region is partially OUTSIDE higher FOV frame, then the background should be regenerated based on neighboring frames since the background does not change relative to camera and the foreground should be generated since the foreground moves relative to camera.

Referring to FIG. 13B, a crop regeneration region 1304b is partially outside the higher FOV frame 1302b. Image 1304b represents a cropped low FOV frame with cropped margin 1306b, thus generating a crop regeneration image 1308b.

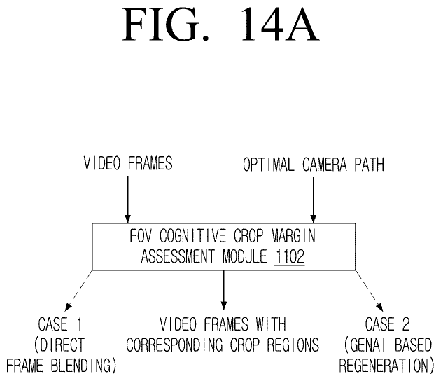

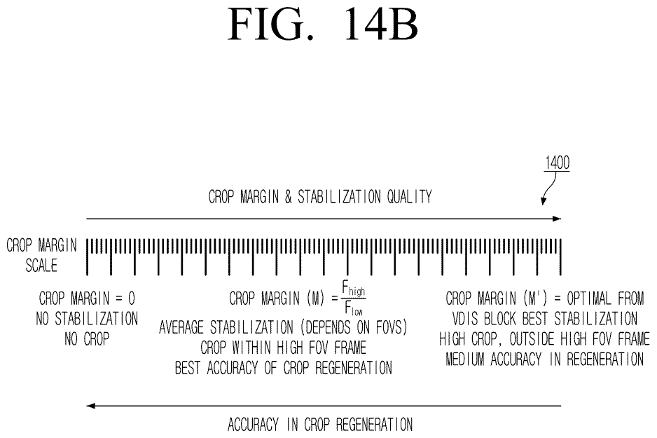

FIG. 14A illustrates a schematic block diagram of a FOV cognitive crop margin assessment module with a gen-AI module, according to an embodiment of the disclosure.

Referring to FIG. 14A, the FOV cognitive crop margin assessment module 1102 receives video frames (low and high FOV) and optimal camera path to obtain crop region based on application of dynamic crop margin as well as iteratively modifying crop margin and crop region based on frame validation. Thus, the output of the FOV cognitive crop margin assessment module 1102 is crop regions in the low FOV frame based on dynamically selected crop margin and different control flow (i.e., case 1 and case 2 as described above).

The FOV cognitive crop margin assessment module 1102 may perform the following operations:

Assume F_low—FOV of low FOV frame in degrees, F_high—FOV of high FOV frame in degrees. The video stabilization module 312 provides an ideal crop margin M′ based on optimal camera path. However, this may be too high for crop regeneration. Hence, the FOV cognitive crop margin assessment module 1102 selects initial crop margin M=F_high/F_low and Case 1 (direct frame blending) is implemented because: even in worst case, crop regeneration region lies within higher FOV frame.

However, if initial crop margin (F_high/F_low) is too low, then it negatively impacts stabilization quality (more shake). Thus, a good trade-off between initial crop margin (for maximum accuracy) and ideal crop margin (for maximum video stabilization) is to be obtained. Further, to improve accuracy, frame validation module 412 is executed after crop regenerated frame are obtained. If the accuracy is worse, then crop margin is decreased so that accuracy is improved while sacrificing some stabilization quality. This is because accuracy has higher precedence compared to stabilization quality.

FIG. 14B illustrates a crop margin scale, according to an embodiment of the disclosure.

Referring to FIG. 14B, the FOV cognitive crop margin assessment module 1102 tries to obtain a trade-off between initial crop margin (for maximum accuracy) and ideal crop margin (for maximum video stabilization) using the crop margin scale. Further, the frame validation module 412 also uses the crop margin scale 1400 to validate the crop re-generated frames.

Thus, the FOV cognitive crop margin assessment module 1102 and the frame validation module 412 may perform the following operations.

Operation 1: Initial crop margin M=F_high/F_low and obtain ideal crop margin from video stabilization block M′ is calculated.

Operation 2: If M′<=M, use M′ as crop margin and ideal camera path from VDIS block directly for best stabilization quality and maximum accuracy. Then case 1 of direct frame blending is performed.

Operation 3: If M′>M, Mₜₕᵣₑₛₕ—tunable threshold margin.

Operation 3(a): If M′−M<=Mₜₕᵣₑₛₕ₁, use M as crop margin and clip the camera path to margin M if it exceeds M. This is near best stabilization quality and no regeneration required and thus, the case 1 of direct frame blending is performed.

Operation 3(b): If Mₜₕᵣₑₛₕ₂>M′−M>Mₜₕᵣₑₛₕ₁, use M′ as crop margin and clip the camera path to margin M′ if it exceeds M+Mₜₕᵣₑₛₕ₁. This is the best stabilization quality and near best accuracy of crop regeneration and Case 2 is performed.

Operation 3(c): If Mₜₕᵣₑₛₕ₂<M′−M, use M+“Mₜₕᵣₑₛₕ₂” as crop margin and clip the camera path to margin M+Mₜₕᵣₑₛₕ₂ if it exceeds M+Mₜₕᵣₑₛₕ₂. This is performing trade-off between best stabilization quality and accuracy of crop regeneration.

According to an embodiment of the disclosure, Mₜₕᵣₑₛₕ₁ is a hyperparameter and is fine-tunable based on FOV difference in Higher FOV video stream and lower FOV video Stream. According to another embodiment, Mₜₕᵣₑₛₕ₂ is a hyperparameter and is fine-tunable based on video use case (high motion or low motion video). Both these parameters remain constant for all frames in certain video

Operation 4: After processing of frames through Gen-AI module 410, if frame regeneration is INVALID according to frame validation block, operations 2 or 3 are performed again based on the M′ and M, and the margin is decreased by a weighted factor and try again.

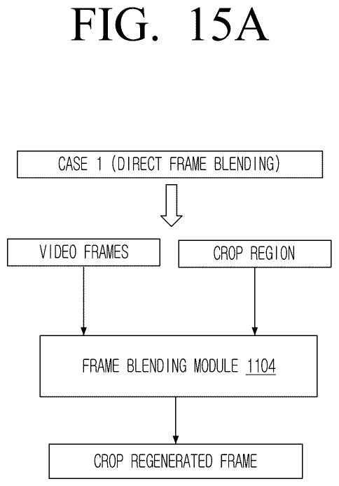

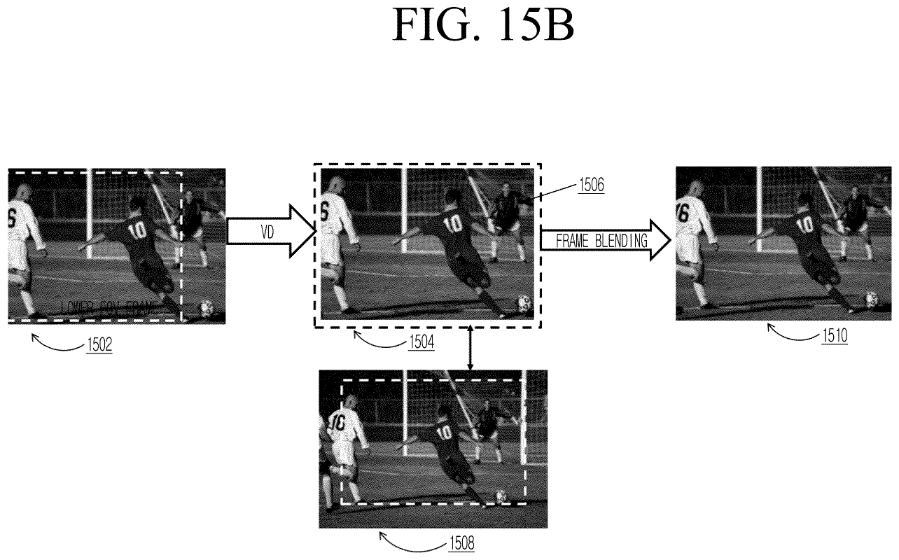

FIG. 15A illustrates a schematic block diagram of a frame blending module, according to an embodiment of the disclosure.

Referring to FIG. 15A, the frame blending module 1104 receives video frames and crop region as an input to regenerate crop region when crop regeneration region is within higher FOV frame. Since crop regeneration region is within higher FOV frame, final output is Crop regenerated Video frame which is equal to lower FOV frame with extra region from aligned and IQ matched higher FOV frame.

FIG. 15B illustrates a scenario of crop regenerated frame by a frame blending module, according to an embodiment of the disclosure.

Referring to FIG. 15B, an image 1502 with low FOV frame is received. An image 1504 is a cropped lower FOV frame with an initial FOV indicated by 1506. An image 1508 indicated aligned and IQ matched higher FOV frame. The frame blending module 1104 processes the images 1504 and 1508 to perform frame blending and obtain a restored FOV image 1510.

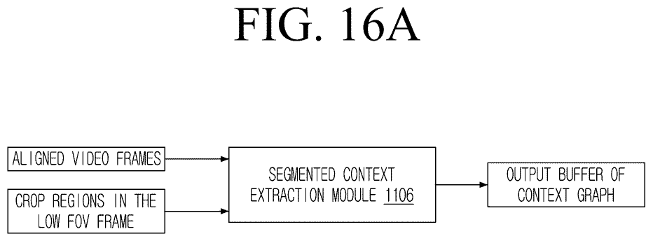

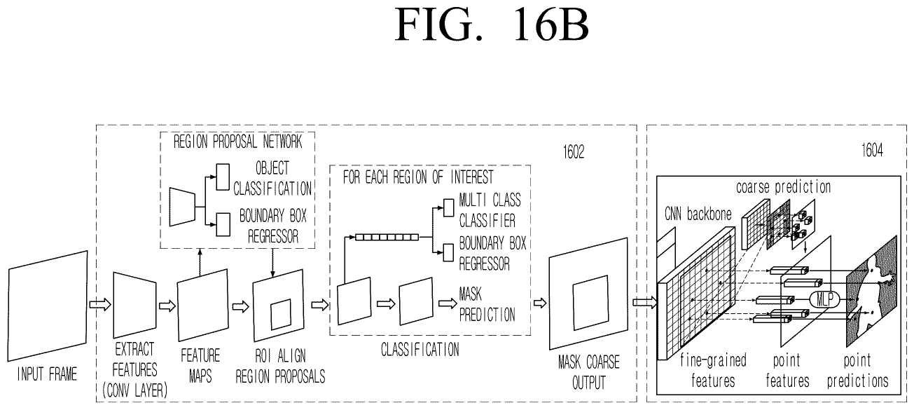

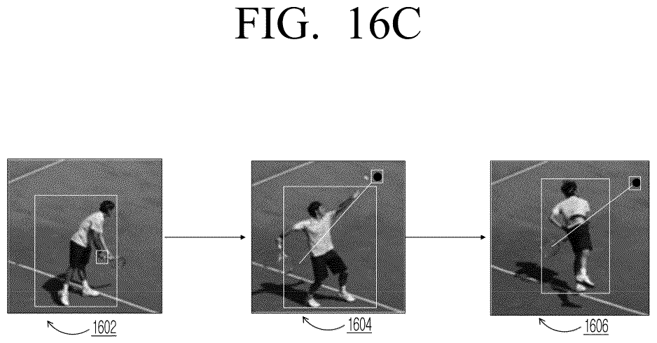

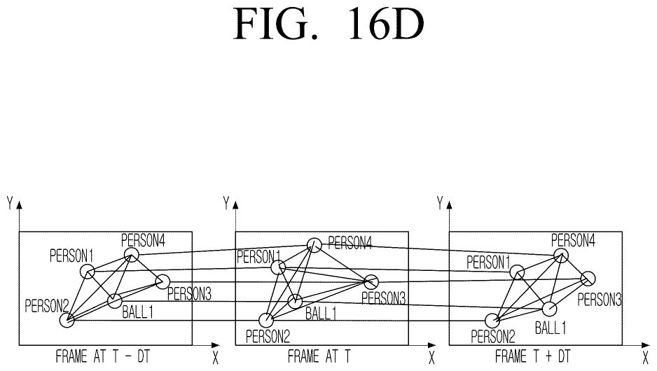

FIG. 16A illustrates a schematic block diagram of the segmented context extraction module 1106, according to an embodiment of the disclosure.

Referring to FIG. 16A, the segmented context extraction module 1106 receives the aligned video frames and crop regions in the low FOV frame as an input to segment and track the behavior of different moving objects present in neighboring dynamic window of frames and obtain output buffer of context graph which contains relationship information between the objects.

FIGS. 16B, 16C, and 16D illustrate methods for segmentation by a segmented context extraction module, according to various embodiments of the disclosure.

Referring to FIGS. 16B-16D, as shown in image 1602, the segmented context extraction module 1106 segments the objects using Mask Region-based Convolutional Neural Network (R-CNN) to provide initial objects and bounding boxes. This provides coarse masks from R-CNN.

At image 1604, to obtain more precise objects, the segmented context extraction module 1106 refines the coarse masks using, for example, PointRend. This enhances the boundaries of the objects, especially where fine details (at the boundary of the objects) are required.

After segmentation, the segmented context extraction module 1106 obtains the motion vector and feature vector of the segmented objects. The segmented context extraction module 1106 performs the object tracking using Optical flow estimation which tracks the object motion across frames to maintain consistent identities and analyze the movement, as shown in FIG. 16C in images 1602, 1604 and 1606. Thus, the segmented context extraction module 1106 generates a motion vector speed and direction of an object across the video frames.

For classification, the segmented context extraction module 1106 uses a pre-trained CNN model to obtain a feature vector for each segmented object.

After features extraction, the segmented context extraction module 1106 determines the relationship between the features similarity, objects' motion relevance. To determine the relationship among the objects, the segmented context extraction module 1106 creates a Context Graph where each object are the nodes, connected with the neighboring nodes. Along with the nodes, the context graph contains all the information of respective objects.

Through Context Graph, the segmented context extraction module 1106 obtains the relationship between pairs of objects (same or different objects) like the relative motion, appearance and distance between objects.

Further, weight of the edges connecting the nodes (objects) are based on the motion consistency, appearance and direction. For example, objects moving together or in a consistent motion have stronger edges. Thus, stronger edges have greater weight compared to weaker edges.

In addition, the relationship may be between different objects within a frame, or same objects in consecutive frames.

A) Edges between two different objects within a frame: In this case, speed and appearance are not significant. Motion direction is significant because the change in direction of one object with respect to another object may be checked.

Let vᵢ and vⱼ are the motion vector of objects i and j respectively.

$${w}_{i j} = \frac{{v}_{i} \cdot {v}_{j}}{‖ {v}_{i} ‖ ‖ {v}_{j} ‖} ,$$

where wᵢⱼ is the weight of the edges between the nodes within the same frame with respect to the motion vector within the frame.

B) Edges between the same objects in the consecutive frames: Connect the graph of a frame with the graph in the neighboring frames. These connect nodes representing the same objects across consecutive frames, capturing the motion continuity of the object with time. The weight of the edges depends on the change in speed, appearance or direction throughout the frames.

Let vᵢ(t) and vᵢ(t+dt) are the motion vector, and fᵢ(t) and fᵢ(t+dt) are the feature vector of same objects at time t and t+dt respectively.

$${w}_{{1}_{t , t + dt}} = \frac{{v}_{i} ( t ) \cdot {v}_{i} ( t + d t )}{‖ {v}_{i} ( t ) ‖ ‖ {v}_{i} ( t + dt ) ‖} = ( weight based on the change in direction ) .$$

This is a direct relationship with the cosine motion vector of two objects.

$${w}_{{2}_{t , t + dt}} = \frac{1}{‖ {v}_{i} ( t ) - {v}_{i} ( t + dt ) ‖} = ( weight based on the change in speed ) .$$

This is an inverse relationship with the difference in speed of two objects.

$${w}_{{3}_{t , t + dt}} = \frac{{f}_{i} ( t ) \cdot {f}_{i} ( t + dt )}{‖ {f}_{i} ( t ) ‖ ‖ {f}_{i} ( t + dt ) ‖} = ( weight based on the change in appearance ) .$$

This is a direct relationship with the cosine similarity of feature vector of two objects.

$${w}_{t , t + dt} = α {w}_{{1}_{t , t + dt}} + β {w}_{{2}_{t , t + dt}} + γ {w}_{{3}_{t , t + dt}} = summing all the above weights .$$

Here, α, β and “γ” are coefficients of w₁_{_{t, t+dt}}, w₂_{_{t, t+dt}} and w₃_{_{t t+dt}} respectively, depends on which similarity is more significant. After creating context graph, add it in a buffer of size n.

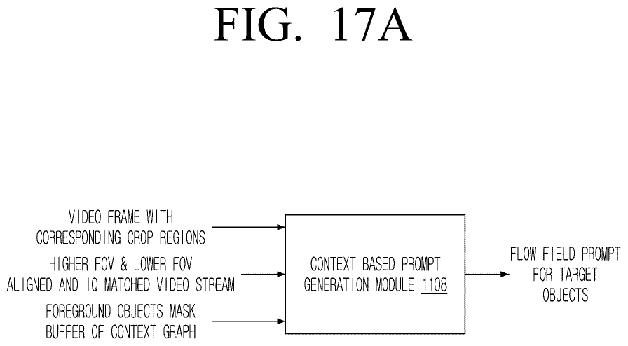

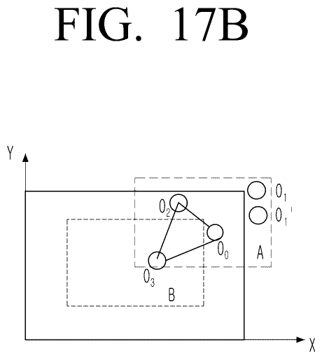

FIG. 17A illustrates a schematic block diagram of a context based prompt generation module 1108 of the system, according to an embodiment of the disclosure.

Referring to FIG. 17A, the context based prompt generation module 1108 receives aligned video frames, higher & lower FOV aligned and IQ matched video stream, foreground object mask and buffer of Context Graph as an input to generate prompt for crop regeneration.

FIG. 17B illustrates a scenario for generating one or more flow field prompts for target object by a context based prompt generation module, according to an embodiment of the disclosure.

Referring to FIG. 17B, the objects that needed to be regenerated are determined:

O₀ (Related Object)=Object that are present in a higher FOV and not in a lower FOV frame

Target Object=Objects that need to be regenerated O₁ and O₁′.

In an example, there are two types of Target Objects:
O₁: Target objects that are related to some object O₀ (according to context graph);
O₁′: Target objects that are not related to any object (according to context graph);
To determine O₀: In the Current Frame C_{F} all the objects that are present in higher FOV frame but not in lower FOV frame are determined. To determine the position of object foreground object masks are used.

To determine O₁ and O₁′: First all the objects that are related to Go are determined by analyzing all the context graph present in a buffer.

From these selected objects all the objects present in Current Frame C_{F} are removed. From the remaining objects average Edge value is calculated.

O₁=If average edge value between the object and O₀ is greater than threshold; then the object is considered as O₁.

O₁′=If average edge value between the object and O₀ is less than threshold; then the object is considered as O₁′.

Further, flow field generation (For O₁ and O₁′, a flow field is predicted and sent as an input to Gen AI module so that the position and orientation are determined in C_{F}).

First, the Last Frame (L_{F}) is determined in for O₁ and O₁′ in which the Target object is present in Higher FOV Frame but nit in lower FOV Frame.

Using the previous frame from L_{F}, the Flow field is calculated for O₀, O₁ and O₁′.

For O₁′, the Flow field is predicted from L_{F} to C_{F} using existing method of Estimation of Optical Flow.

For O₁, the Flow Field is predicted taking help of the related object O₀. Flow field till L_{F} is analyzed for O₁ & O₀ and a vector relation between them is analyzed (V₀₁)

To calculate V₀: an Average Flow Field Vector is calculated and vector subtraction is done between Average Flow Field of O₁ and Average Flow Field Vector of O₀.

Thus, when V₀₁ is added to Flow Field Of O₀ in C_{F} the result is an extended Flow Field from L_{F} to C_{F} for O₁.

With the Extended Flow from L_{F} to C_{F} for O₁ and O₁′, if the estimated position of O₁ and O₁′ lies in the crop margin then the calculated flow field is passed to Gen AI module.

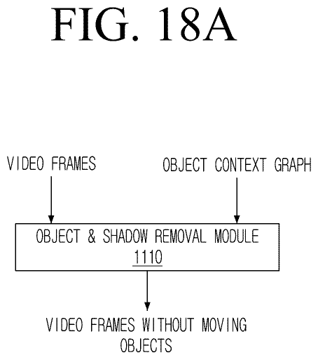

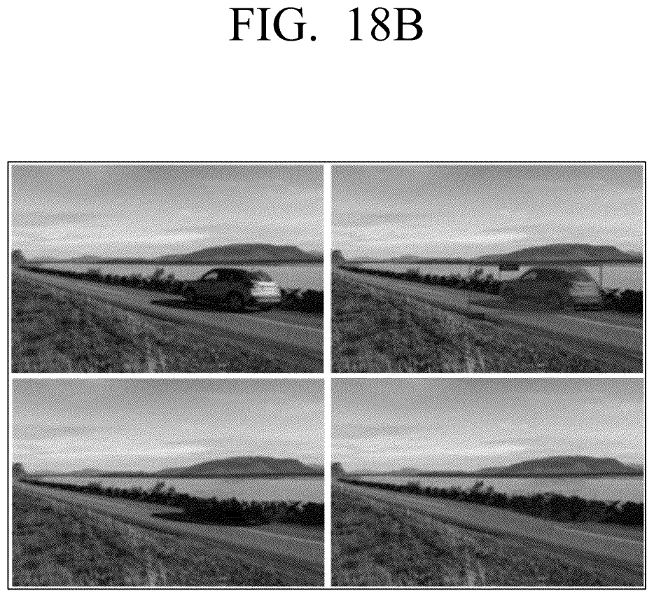

FIG. 18A illustrates a schematic block diagram of an object and shadow removal module of the system, according to an embodiment of the disclosure. FIG. 18B illustrates a scenario for generating video frames with objects and shadows removed by the object and shadow removal module, according to an embodiment of the disclosure.

Referring to FIGS. 18A and 18B, the object and shadow removal module 1110 receives video frames and object context graph as an input to edit input frames such that any moving objects as detected by previous block is removed along with shadow.

The removal of objects and shadows from the video frame, as shown in FIG. 18b, is needed so that while blending frames to obtain background, foreground objects are not present. The disclosure uses Convolutional Neural Network in combination with Instance Region Proposal Network (RPN) to find regions that are highly likely to contain shadows and then find object-shadow associations using methods such as RoIAlign. The RoIAlign is an operation for extracting a small feature map from each region of interest in detection and segmentation-based tasks. It properly aligns the extracted features with input.

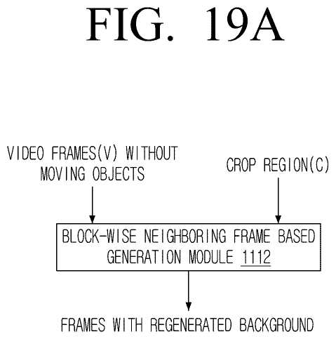

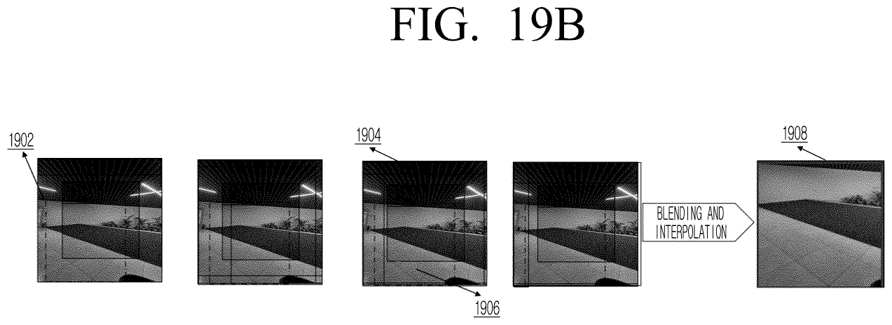

FIG. 19A illustrates a schematic block diagram of a block-wise neighboring frame-based generation module, according to an embodiment of the disclosure.

Referring to FIG. 19A, the block-wise neighboring frame-based generation module 1112 receives video frames (low and high FOV) without moving objects and crop regions in the low FOV frame as an input to dynamically select high quality candidate frames with information about the cropped sections for interpolating and blending the background sections and thus, obtaining frames with regenerated background based on crop margin as output.

The block-wise neighboring frame-based generation module 1112 identifies all the video frames (high FOV F_{high}) with any information about the cropped section with a maximum of 20 frames (Candidate Frames). The module 1112 selects high quality frames among the Candidate Frames (Selected Frames). The module 1112 then performs interpolation and blending of the selected frames to generate the output. If there is a portion of cropped sections not found in any Selected Frame, then the module 1112 extrapolates that background portion.

FIG. 19B illustrates a scenario for generating frames with regenerated backgrounds by a block-wise neighboring frame based generation module, according to an embodiment of the disclosure.

Referring to FIG. 19B, selection of neighboring frames (e.g., 1902, 1904, 1906) with information about the crop region is shown. Only the good quality neighboring frames which have any information about the cropped region are selected. Since many such frames may be available, the number of neighboring frames may be limited to, for example, 20 frames. Thus, out of the 20 frames, 10 may be past frames and 10 frames may be future frames. Accordingly, the background 1908 corresponding to the crop region is generated through blending and interpolation.

An operation performed by the block-wise neighboring frame based generation module 1112 may be:

Identification of matching video frames (high FOV F_{high}) called candidate frames (C).

Extracting features from cropped section using image processing techniques or pre-trained trained Deep Learning models (CNNs). Features include color histograms, edge detection, texture patterns or more complex features learned by neural networks.

Searching for similar features in neighboring frames through frame-by-frame comparison using a matching algorithm like template matching, feature matching, or any similarity scores using metrics like mean squared error, or a learned similarity metric. Selection of high quality frames from the candidate frames (C).

The block-wise neighboring frame based generation module 1112 uses a combination of factors like blur, sharpness and Image Quality (IQ) similarity to select good quality frames. For each frame, the block-wise neighboring frame based generation module 1112:

Calculates the Blur Factor (BF): By using the Laplacian variance method to estimate the blur. A low variance indicates a blurry image.

Calculates the Sharpness Factor (SF): Using the Gradient Magnitude to estimate the sharpness. Higher gradients correspond to sharper images.

Calculates IQ Similarity (IQS): Using Structural Similarity Index (SSIM) to measure the similarity between the cropped section and the matching region in the neighboring frames. Greater IQS correspond to similar images.

The block-wise neighboring frame based generation module 1112, then uses weighted average between (Inverse of BF), SF and IQS:

$$Weighted\_Match ( WM ) = blur\_weight * {BF}^{- 1} + sharpness\_weight * SF + iq\_weight * IQS$$

$$Constraint : blur\_weight + sharpness\_weight + iq\_weight = 1.$$

The block-wise neighboring frame based generation module 1112 then performs application of threshold: Defining a threshold for the weighted score to determine if the frame is acceptable.

Then, the block-wise neighboring frame based generation module 1112 selects the frames if: WM>=Threshold (TH).

The block-wise neighboring frame based generation module 1112, then by combining these factors through a weighted score and applying a threshold, selects the best quality frames from among the matching frames. The weights based on specific needs is adjusted.

Using any known Interpolation technique (e.g., Linear, Optical Flow-Based, Deep Learning-Based like DAIN), the block-wise neighboring frame based generation module 1112 generates the output from the selected frames.

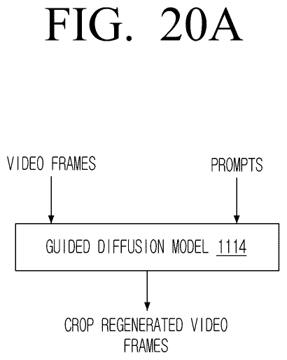

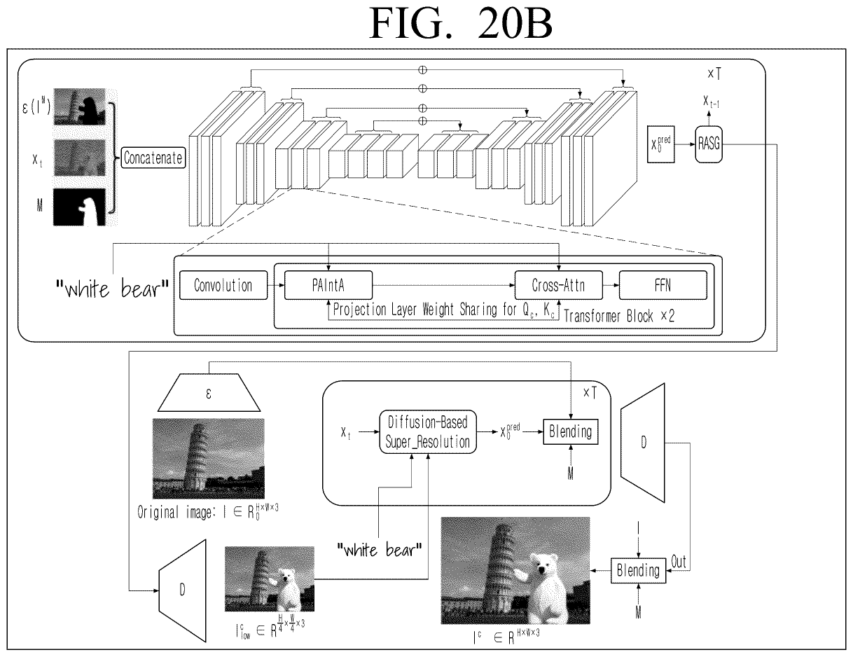

FIG. 20A illustrates a schematic block diagram of a guided diffusion model, according to an embodiment of the disclosure.

Referring to FIG. 20A, the guided diffusion model 1114 receives video frames and flow field prompts as an input to generate marked regions in the frames based on provided Flow Field prompts thus obtaining crop regenerated video frames.

FIG. 20B illustrates a scenario for generating crop regenerated video frames by a guided diffusion model, according to an embodiment of the disclosure.

Referring to FIG. 20B, an image with mask is provided, along with a prompt. The model is trained to regenerate the masked region with the prompt. In this case, convolution on neighboring frames is applied to embed extra information into projection layer.

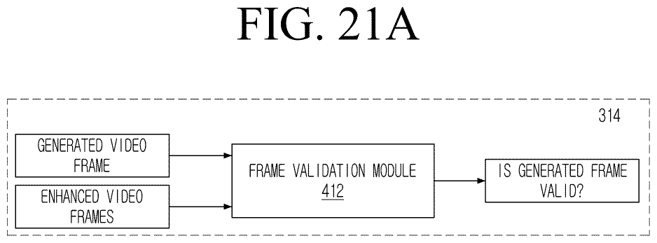

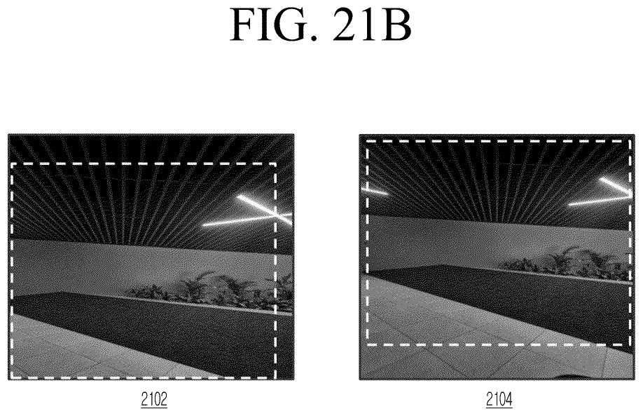

FIG. 21A illustrates a schematic block diagram of a frame validation module, according to an embodiment of the disclosure.

Referring to FIG. 21A, the frame validation module 412 receives generated video frame and enhanced video frames as an input to check if generated frame is valid or not by matching the current frame with the neighboring frames for correctness of shape and relative position.

FIG. 21B illustrates a scenario for frame validation by a frame validation module, according to an embodiment of the disclosure.

Referring to FIG. 21B, to perform validation for background, the frame validation module 412 compares pixel-wise luminance value and edge map with neighboring frames since these metrics do not change suddenly for background.

In the frame validation module 412, first, all of the frames in frame window are aligned to each other using point feature matching and warping. Once the frames are aligned Block matching is done to determine the overlapping region of current frame with the neighboring frames by the frame validation module 412. In the frame validation module 412, after the Overlapping regions are determined, each Frame is converted to YUV Frame so that Pixel wise luminance may be compared easily.

If luminance matches, edge detection is done to create an edge map. Since the frames are aligned background edges of neighboring frame must overlap with the one of a current frame, as shown in the neighboring frame 2102 and the generated frame 2104.

For checking the regenerated foreground object, luminance and edge cannot be checked; since these objects are moving, these metrics may vary. Instead, motion values are analyzed for these regenerated foreground object by the frame validation module 412.

First, Interest points are determined on these foreground objects so that object motion may be tracked easily. Using the motion estimation of these points, the trajectory of each foreground object across a video is mapped. Through motion estimation graph or trajectory of foreground object, motion vector (Position, Speed & Direction) of Foreground object in current frame is compared with the neighboring frame by the frame validation module 412.

If any metric of a Foreground object changes abruptly compared to neighboring frame, that mean the Foreground object's regeneration is wrong for current frame by the frame validation module 412, as follows.

$$Speed = \frac{Change in Position}{Time} = \frac{‖ {P}_{i} ( t + d t ) - {P}_{i} ( t ) ‖}{d t}$$

where Pᵢ(t) and Pᵢ(t+dt) are the position vectors of object i at time t and t+dt respectively.

$$Change in direction = {cos}^{- 1} ( \frac{{v}_{i} ( t ) \cdot {v}_{i} ( t + d t )}{‖ {v}_{i} ( t ) ‖ ‖ {v}_{i} ( t + dt ) ‖} )$$

where vᵢ(t) and vᵢ(t+dt) are the motion vectors of object i at time t and t+dt respectively.

To track abrupt changes first position metric is determined and frames in which are crop region is beyond Higher FOV are analyzed for below specific cases (taking context graph of neighboring frames) by the frame validation module 412:

If the position is beyond Higher FOV frame for current Frame but present in neighboring frame: Context Relation Graph of Neighboring Frame is compared with that of Current Frame by the frame validation module 412.

If the position is beyond the Higher FOV frame for current Frame but the object is not related to any other object, then the object's velocity, feature, and motion vector from neighboring frame are compared to check for abrupt regeneration by the frame validation module 412.

If the position is under Higher FOV frame for the current Frame but beyond in a past frame, then position and velocity metrics from future frames are reverse extrapolated to check position in past frame by the frame validation module 412, as follows.

$${w}_{i j} = \frac{{v}_{i} \cdot {v}_{j}}{‖ {v}_{i} ‖ ‖ {v}_{j} ‖} ,$$

where wᵢⱼ is the weight of the edges between the nodes within the same frame with respect to the motion vector within the frame.

$${w}_{{1}_{t , t + dt}} = \frac{{v}_{i} ( t ) \cdot {v}_{i} ( t + d t )}{‖ {v}_{i} ( t ) ‖ ‖ {v}_{i} ( t + dt ) ‖} = ( weight based on the change in direction ) .$$

This is a direct relationship with the cosine motion vector of two objects.

$${w}_{{2}_{t , t + dt}} = \frac{1}{‖ {v}_{i} ( t ) - {v}_{i} ( t + dt ) ‖} = ( weight based on the change in speed ) .$$

This is an inverse relationship with the difference in speed of two objects.

$${w}_{{3}_{t , t + dt}} = \frac{{f}_{i} ( t ) \cdot {f}_{i} ( t + dt )}{‖ {f}_{i} ( t ) ‖ ‖ {f}_{i} ( t + dt ) ‖} = ( weight based on the change in appearance ) .$$

This is direct relationship with the cosine similarity of feature vector of two objects.

If regeneration is invalid, then the frame validation module 412 tunes internal parameters iteratively.

For crop margin: moving close to initial crop margin

$$( \frac{{F}_{high}}{{F}_{low}} )$$

increases crop regeneration accuracy. Hence, frame validation module 412 updates current margin by weighted factor (W).

$$New margin = ( Current margin ) * W + ( \frac{{F}_{high}}{{F}_{low}} ) * ( 1 - W ) .$$

‘W’ starts at 0.8 and decreases linearly to 0 depending on number of times the regeneration for a given frame is invalid.

For Neighboring frame window: candidate neighboring frame windows=20, 16, 8, 4, 2. If background regeneration is invalid, frame validation module 412 starts with window=2 and increases for each invalid iteration. This ensures background consistency with closest frames.

If foreground regeneration is invalid, the frame validation module 412 starts with window=20 and decreases for each invalid iteration. This ensures that foreground context graph covers maximum information.

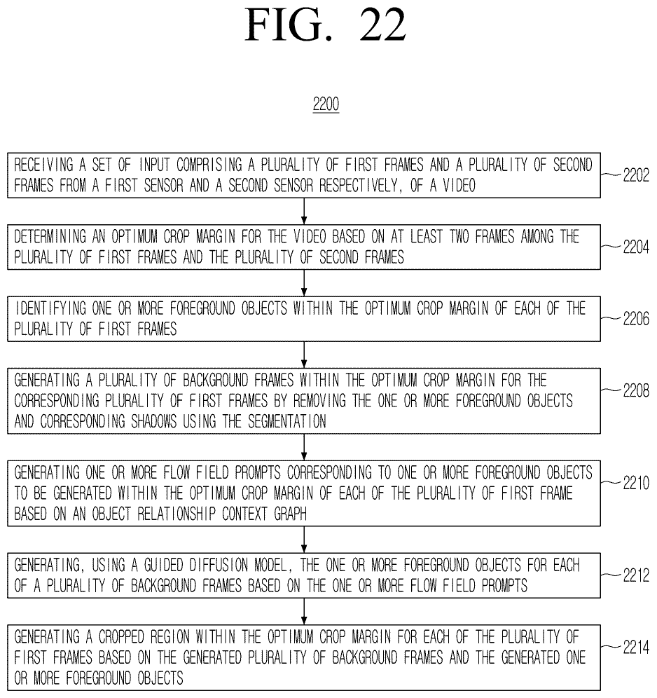

FIG. 22 illustrates a flow chart showing a method for full frame video stabilization, in accordance with an embodiment of the disclosure.

Referring to FIG. 22, in operation 2202, the method 2200 includes receiving a set of an input comprising a plurality of first frames and a plurality of second frames from a first sensor and a second sensor respectively, of a video.

In operation 2204, the method 2200 includes determining an optimum crop margin for the video based on at least two frames among the plurality of first frames and the plurality of second frames.

In operation 2206, the method 2200 includes identifying one or more foreground objects within the optimum crop margin of each of the plurality of first frames.

In operation 2208, the method 2200 includes generating a plurality of background frames within the optimum crop margin for the corresponding plurality of first frames by removing the one or more foreground objects and corresponding shadows using the segmentation. The method 2200 may include splitting the plurality of first frames and the plurality of second frames into a plurality of foreground frames and a plurality of background frames. In the plurality of background frames, one or more portions is stationary relative to background and in the plurality of foreground frames one or more portions of the plurality of first frames and the plurality of second frames which is in motion relative to the background.

In operation 2210, the method 2200 includes generating one or more flow field prompts corresponding to one or more foreground objects to be generated within the optimum crop margin of each of the plurality of first frame based on an object relationship context graph.

The method 2200 may include determining one or more characteristics corresponding to the one or more foreground objects. The one or more characteristics comprises one or more of a motion, a position, and a size of the one or more foreground objects.

The method 2200 may include obtaining the relationship context graph based on the determined one or more characteristics of each of the foreground objects with respect to each other.

The method 2200 may include obtaining a bounding box corresponding to each of the one or more foreground objects. The method 2200 may include determining a motion vector of to the each of one or more foreground objects within the corresponding bounding box. The method 2200 may include determining a feature vector of the segmented one or more foreground objects within the bounding box. The method 2200 may include obtaining the object relationship context graph based on the determined motion vector and the determined feature vector corresponding to each of the one or more foreground objects.

In operation 2212, the method 2200 includes generating, using a guided diffusion model, the one or more foreground objects for each of a plurality of background frames based on the one or more flow field prompts.

In operation 2214, the method 2200 includes generating a cropped region within the optimum crop margin for each of the plurality of first frames based on the generated plurality of background frames and the generated one or more foreground objects.

The method 2200 may include obtaining an initial crop margin value and an ideal crop margin value for each of the plurality of first frames. The method 2200 may include determining a tradeoff between the initial crop margin value and the ideal crop margin value to re-estimate the optimum crop margin for each of the plurality of first frame to generate a valid plurality of foreground frames. The method 2200 may include extrapolating the optimum cropped margin from the plurality of background frames if the candidate frames are not identified.

The method 2200 may include extracting one or more features from the optimum cropped margin using at least one of one or more predetermined image processing techniques and one or more pre trained Convolution Neural Networks (CNNs), wherein the one or more features comprises one or more of color histogram, edge detection, texture pattern.

The method 2200 may include searching for the extracted one or more features in neighboring frames through a frame-by-frame comparison. The method 2200 comprises combining one or more factors such as blur, sharpness and Image Quality (IQ) similarity with interpolation technique to identify candidate frames for blending the plurality of background frames in the optimum cropped margin.

Thus, the disclosure enables usage of high crop margin, which boosts the quality of stabilization. Further, the disclosure takes care of the downside of having a high crop margin (i.e. FOV loss) by accurately regenerating the cropped regions with high degrees of accuracy.

In this application, unless specifically stated otherwise, the use of the singular includes the plural, and the use of “or” means “and/or.” Furthermore, use of the terms “including” or “having” is not limiting. Any range described herein will be understood to include the endpoints and all values between the endpoints. Features of the disclosed embodiments may be combined, rearranged, omitted, etc., within the scope of the disclosure to produce additional embodiments. Furthermore, certain features may sometimes be used to advantage without a corresponding use of other features.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for full frame video stabilization, the method comprising:
receiving a set of inputs including a plurality of first frames and a plurality of second frames from a first sensor and a second sensor respectively, of a video;
determining an optimum crop margin for the video based on at least two frames among the plurality of first frames and the plurality of second frames;
identifying one or more foreground objects within the optimum crop margin of each of the plurality of first frames;
generating a plurality of background frames within the optimum crop margin for the corresponding plurality of first frames by removing the one or more foreground objects and corresponding shadows using segmentation;
generating one or more flow field prompts corresponding to one or more foreground objects to be generated within the optimum crop margin of each of the plurality of first frames based on an object relationship context graph;
generating, using a guided diffusion model, the one or more foreground objects for each of the plurality of background frames based on the one or more flow field prompts; and
generating a cropped region within the optimum crop margin for each of the plurality of first frames based on the generated plurality of background frames and the generated one or more foreground objects.

2. The method as claimed in claim 1, wherein the first sensor and the second sensor have different fields of view.

3. The method as claimed in claim 1, further comprising:
determining one or more characteristics corresponding to the one or more foreground objects, wherein, the one or more characteristics comprises one or more of a motion, a position, and a size of the one or more foreground objects; and
obtaining the relationship context graph based on the determined one or more characteristics of each of the foreground objects with respect to each other.

4. The method as claimed in claim 1,
wherein generating a plurality of background frames within the optimum crop margin using the segmentation comprises:
splitting the plurality of first frames and the plurality of second frames into a plurality of foreground frames and a plurality of background frames, and
wherein in the plurality of background frames, one or more portions is stationary relative to background and in the plurality of foreground frames one or more portions of the plurality of first frames and the plurality of second frames which is in motion relative to the background.

5. The method as claimed in claim 3, wherein obtaining the object relationship context graph comprises:
obtaining a bounding box corresponding to each of the one or more foreground objects;
determining a motion vector of to the each of one or more foreground objects within the corresponding bounding box;
determining a feature vector of the segmented one or more foreground objects within the bounding box; and
obtaining the object relationship context graph based on the determined motion vector and the determined feature vector corresponding to each of the one or more foreground objects.

6. The method as claimed in claim 1, further comprising:
obtaining an initial crop margin value and an ideal crop margin value for each of the plurality of first frames; and
determining a tradeoff between the initial crop margin value and the ideal crop margin value to re-estimate the optimum crop margin for each of the plurality of first frame so as to generate a valid plurality of foreground frames.

7. The method as claimed in claim 1, further comprising:
extracting one or more features from the optimum cropped margin using at least one of one or more predetermined image processing techniques and one or more pre trained convolution neural networks (CNNs), wherein the one or more features include one or more of color histogram, edge detection, texture pattern;
searching for the extracted one or more features in neighboring frames through a frame-by-frame comparison; and
combining one or more factors include at least one of blur, sharpness and image quality (IQ) similarity with interpolation technique to identify candidate frames for blending the plurality of background frames in the optimum cropped margin.

8. The method as claimed in claim 7, further comprising:
extrapolating the optimum cropped margin from the plurality of background frames if the candidate frames are not identified.

9. A system for full frame video stabilization, the system comprising:
one or more processors; and
memory coupled with the one or more processors, including storage media storing instructions,
wherein the instructions, when executed by the one or more processors individually or collectively, cause the system to:
receive a set of inputs comprising a plurality of first frames and a plurality of second frames from a first sensor and a second sensor respectively, of a video,
determine an optimum crop margin for the video based on at least two frames among the plurality of first frames and the plurality of second frames,
identify one or more foreground objects within the optimum crop margin of each of the plurality of first frames,
generate a plurality of background frames within the optimum crop margin for the corresponding plurality of first frames by removing the one or more foreground objects and corresponding shadows using segmentation,
generate one or more flow field prompts corresponding to one or more foreground objects to be generated within the optimum crop margin of each of the plurality of first frames based on an object relationship context graph,
generate, using a guided diffusion model, the one or more foreground objects for each of the plurality of background frames based on the one or more flow field prompts, and
generate a cropped region within the optimum crop margin for each of the plurality of first frames based on the generated plurality of background frames and the generated one or more foreground objects.

10. The system as claimed in claim 9, wherein the first sensor and the second sensor are of different field of view.

11. The system as claimed in claim 9, the instructions, when executed by the one or more processors individually or collectively, further cause the system to:
determine one or more characteristics corresponding to the one or more foreground objects, wherein, the one or more characteristics comprises one or more of a motion, a position, and a size of the one or more foreground objects; and
obtain the relationship context graph based on the determined one or more characteristics of each of the foreground objects with respect to each other.

12. The system as claimed in claim 9,
wherein to generate a plurality of background frames within the optimum crop margin using the segmentation, the instructions, when executed by the one or more processors individually or collectively, further cause the system to:
splitting the plurality of first frames and the plurality of second frames into a plurality of foreground frames and a plurality of background frames, and
wherein in the plurality of background frames, one or more portions is stationary relative to background and in the plurality of foreground frames one or more portions of the plurality of first frames and the plurality of second frames which is in motion relative to the background.

13. The system as claimed in claim 11, wherein to obtain the object relationship context graph, the instructions, when executed by the one or more processors individually or collectively, further cause the system to:
obtain a bounding box corresponding to each of the one or more foreground objects;
determine a motion vector of to the each of one or more foreground objects within the corresponding bounding box;
determine a feature vector of the segmented one or more foreground objects within the bounding box; and
obtain the object relationship context graph based on the determined motion vector and the determined feature vector corresponding to each of the one or more foreground objects.

14. The system as claimed in claim 9, wherein the instructions, when executed by the one or more processors individually or collectively, further cause the system to:
obtain an initial crop margin value and an ideal crop margin value for each of the plurality of first frames; and
determine a tradeoff between the initial crop margin value and the ideal crop margin value to re-estimate the optimum crop margin for each of the plurality of first frame to generate a valid plurality of foreground frames.

15. The system as claimed in claim 9, wherein the instructions, when executed by the one or more processors individually or collectively, further cause the system to:
extract one or more features from the optimum cropped margin using at least one of one or more predetermined image processing techniques and one or more pre trained convolution neural networks (CNNs), wherein the one or more features comprises one or more of color histogram, edge detection, texture pattern,
search for the extracted one or more features in neighboring frames through a frame-by-frame comparison, and
combine one or more factors such as blur, sharpness and image quality (IQ) similarity with interpolation technique to identify candidate frames for blending the plurality of background frames in the optimum cropped margin.

16. The system of claim 15, wherein the instructions, when executed by the one or more processors individually or collectively, further cause the system to extrapolate the optimum cropped margin from the plurality of background frames if the candidate frames are not identified.

17. The system of claim 11, wherein the one or more characteristics include one or more of a motion, a position, and a size of the one or more foreground objects.

18. The system of claim 9, wherein the instructions, when executed by the one or more processors individually or collectively, further cause the system to:
determine whether the generated cropped region is valid, and
when the generated cropped region is not valid:
obtain an initial crop margin value and an ideal crop margin value for each of the plurality of first frame
determine a tradeoff between the initial crop margin value and the ideal crop margin value,
re-estimate the optimum crop margin for each of the plurality of first frame based on the determined tradeoff, and
generate a valid plurality of foreground frames based on the re-estimated optimum crop margin.

19. One or more non-transitory computer-readable storage media storing one or more computer programs including computer-executable instructions that, when executed by one or more processors of an electronic device individually or collectively, cause the electronic device to perform operations, the operations comprising:
receiving a set of inputs comprising a plurality of first frames and a plurality of second frames from a first sensor and a second sensor respectively, of a video;
determining an optimum crop margin for the video based on at least two frames among the plurality of first frames and the plurality of second frames;
identifying one or more foreground objects within the optimum crop margin of each of the plurality of first frames;
generating a plurality of background frames within the optimum crop margin for the corresponding plurality of first frames by removing the one or more foreground objects and corresponding shadows using segmentation;
generating one or more flow field prompts corresponding to one or more foreground objects to be generated within the optimum crop margin of each of the plurality of first frames based on an object relationship context graph;
generating, using a guided diffusion model, the one or more foreground objects for each of the plurality of background frames based on the one or more flow field prompts; and
generating a cropped region within the optimum crop margin for each of the plurality of first frames based on the generated plurality of background frames and the generated one or more foreground objects.

20. The one or more non-transitory computer-readable storage media of claim 19, the operations further comprising:
determining one or more characteristics corresponding to the one or more foreground objects, wherein, the one or more characteristics comprises one or more of a motion, a position, and a size of the one or more foreground objects; and
obtaining the relationship context graph based on the determined one or more characteristics of each of the foreground objects with respect to each other.
